(19) United States
(12) Patent Application Publication
(10) Pub. No.: US 2012/0052809 A1
(43) Pub. Date: Mar. 1, 2012

(54) Two parts smart phone

(76) Inventor: Shiquan Wu, Ottawa (CA)

(21) Appl. No.: 13/137,549

(22) Filed: Aug. 25, 2011

Related U.S. Application Data
(60) Provisional application No. 61/344,625, filed on Sep. 1, 2010.
(60) Provisional application No. 61/344,625, filed on Sep. 1, 2010.

(51) Int. Cl. H04B 7/00

(52) U.S. Cl. 455/41.3

(57) ABSTRACT

A smart phone has a pocket unit and a handheld unit. Handheld can slide into pocket to be one piece phone. Pocket unit is responsible for cellular side communication and relay the signals from/to handheld. It can be put aside or into bag or hanged on the belt so that there are no higher power radios pointing to the human's brain and has less signal quality loss. Handheld unit is responsible for personal ambience communication, user interfaces and always associated with pocket unit via an alarm unit. In this way, wireless phone can be designed and manufactured according long range communication performance and short range communication performance and user interfaces.

### CLAIM OF PRIORITY

This patent application claims the benefit of priority from U.S. Provisional Patent Application No. 61/344,625 filed on Sep. 1, 2010. This application incorporates by reference the entire disclosure of U.S. Provisional Patent Application No. 61/344,625.

### FIELD OF THE INVENTION

The disclosure relates generally to wireless smart phone system having two units that can be separated when in communication, wherein the first unit communicates with the cellular network in lower frequency and has no screen, no key pad, no microphone and speaker etc., while the second unit communicates with first unit only in higher frequency and has a display screen and a keypad etc.

### BACKGROUND OF THE INVENTION

Wireless communication is to use electromagnetic wave or radio frequency (RF) to carry information over the communication path. For bidirectional wireless communications, one end usually refers to base station (BTS) or access point (AP) and the other end refers to terminals or user equipments (UE). Both BTS and UE have a transceiver unit. Although the design of BTS transceiver unit and UE transceiver unit can be quite different due to different requirements, the common practice is that one end transmits at a carrier frequency fc; the other end must receive at the same frequency fc. Therefore, the transceiver chipsets designed and manufactured today all associated with a designated frequency or a spectrum. It is very common that a smart phone today has integrated multiple radios such as GSM (Global System for Mobile), CDMA (Code Division Multiple Access), WCDMA (Wide band CDMA), IEEE 802.11, and BlueTooth, GPS (global positioning system) etc. These also need multiple antennas and multiple digital signal processors and multiple protocols processors. This type of phone not only wastes the resources and causes RF pollution, but also raises the health concerns when multiple radios are simultaneously pointing to human's brain.

An object of the invention is to provide an architect to make the wireless phone design has two parts with two different functions. One part, is similar to a PC concept which has a Pentium chip, concentrates on the long range communication only. Another part, is similar to the monitor, concentrates on the user interface and personal ambience communication.

Another object of the invention is to relax the health concern and body loss issue by separating the cellular side communication and the personal ambience communication.

The foregoing embodiments and advantages of the invention are illustrative that can be implemented by various exemplary embodiments. Thus, these and other embodiments and advantages of the various exemplary embodiments will be apparent from the illustrations, figures and examples herein or can be learned from the various exemplary embodiments, both as embodied herein or as modified in terms of any variation that are apparent to those persons skilled in the art.

### SUMMARY OF THE INVENTION

According to one broad aspect, the invention discloses a smart phone system architecture which comprises a pocket unit and a handheld unit; the pocket unit is responsible for longer distance communication while the handheld unit is limited to personal ambience communication and two parts are binding together with ranging alarms.

The pocket unit is for cellular side communication and comprising: an antenna set, a long range radio chipset such as a cellular chipset, a co-processor and a short distance wireless chipset such as an IEEE 802.11 chipset.

The handheld unit only communicates with pocket unit and comprising: An antenna set, another a short distance chipset such as IEEE 802.11 chipset, a LCD display, Audio codec PCM/G711, microphone and speaker, a programmable ranging alarm unit.

In one embodiment, the pocket unit communicates with cellular network using cellular frequency and communicates with handheld unit using IEEE 802.11 frequency, preferably in higher frequencies.

In another embodiment, handheld will compute and trigger an alarm when handheld is out of the predefined range, say 30 meters.

Yet in another embodiment, pocket unit will compute and trigger an alarm when the handheld associated with it is out of predefined range or out of its control.

We will provide brief summaries of various exemplary embodiments. Some simplifications and omissions may be made to highlight some aspects of the various exemplary embodiments. Detailed descriptions of a preferred exemplary embodiment are adequate to those skilled persons in the art to use and to modify the inventive system concepts and means.

### DESCRIPTION OF DRAWINGS

FIG. 1 shows some popular smart phones today.

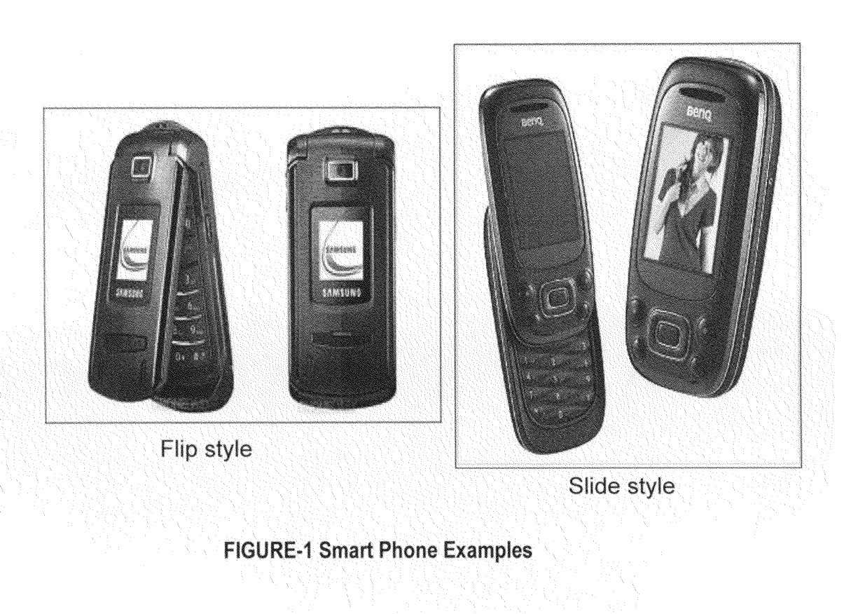

FIG. 2 illustrates one embodiment of the invention, wherein a smart phone composes of two separate units.

FIG. 3 describes the rear side look of the two-parts phone

FIG. 4 shows an architecture of the handheld unit

FIG. 5 shows an architecture of the pocket unit

FIG. 6 illustrates the relay functionality of the pocket unit

FIG. 7 illustrates the outgoing call procedures

FIG. 8 describes the incoming call procedures

### DETAILED DESCRIPTION OF THE INVENTION

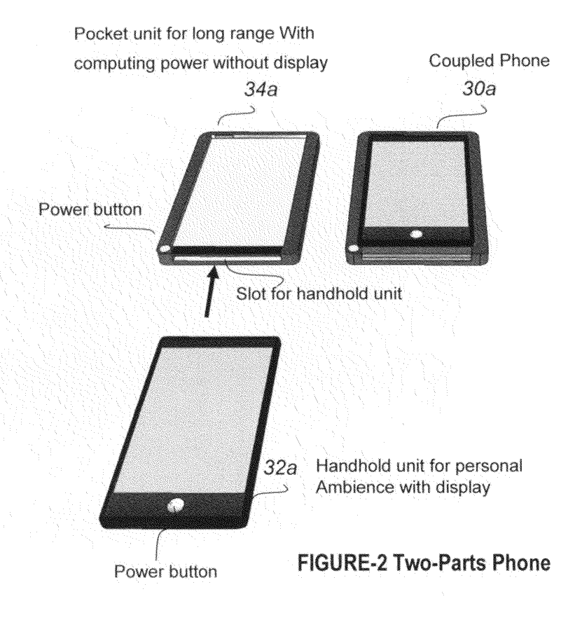

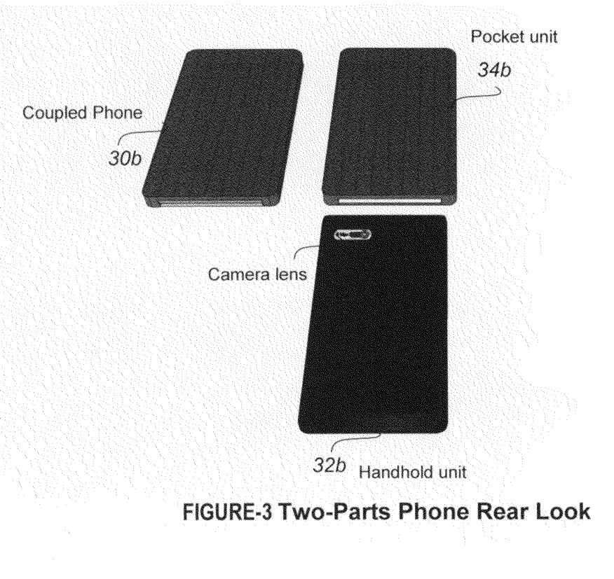

Referring to FIG. 2 and FIG. 3, there is an illustrated embodiment, wherein a smart phone has two units—pocket unit and handheld unit. The two units can stick together or can be separated with predefined maximum distance, say 30 meters. When two units are separated beyond the predefined distance, two units will trigger alarms and get attention from his owner.

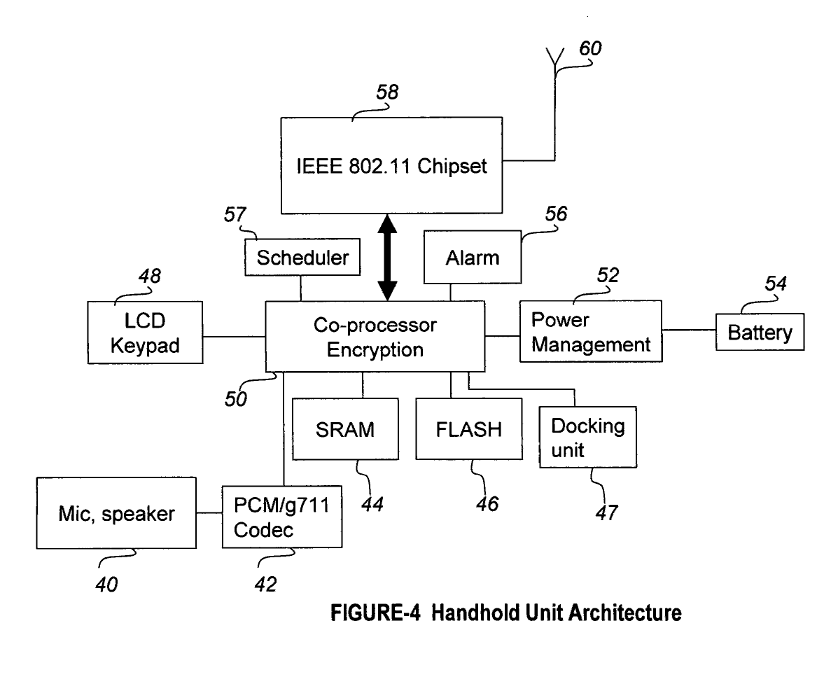

Referring to FIG. 4, there is an illustrated embodiment, wherein the handheld unit comprising: a microphone 40, a PCM (pulse code modulation)/G711 voice codec 42, SRAM (static random access memory) 44, FLASH 46, display and keypad 48, coprocessor 50, Battery unit 54, power management module 52, alarm unit 56, a scheduler 57, IEEE 802.11 chipset 58 and antenna set 60.

An advantage of this embodiment resides in the fact that the handheld only relies on the IEEE 802.11 chipset and can make calls to cellular network through the generic PCM voice codec conversion. Another advantage of this embodiment is that when IEEE 802.11 chipset operates in higher frequencies such as 60 GHz (New IEEE 802.11 standard), the handheld can be extremely low power therefore has less radiation for human's brain. Yet another advantage of this embodiment is that the alarm unit will guarantee the handheld is always within the proximity of the pocket unit.

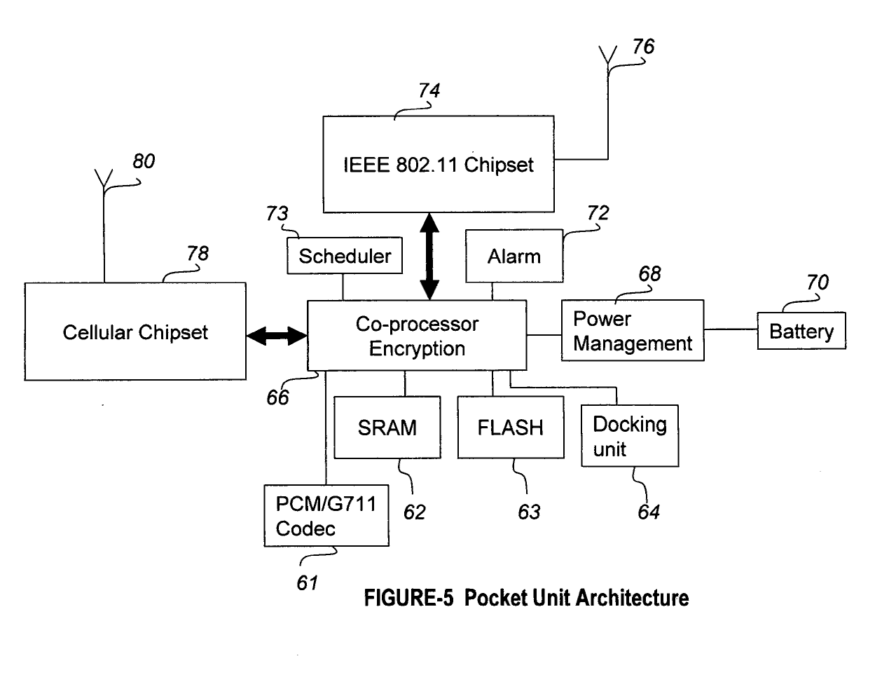

Referring to FIG. 5, there is another illustrated embodiment, wherein the pocket unit comprising: a PCM/G711 voice codec 61, SRAM 62, FLASH 63, docking unit 64, coprocessor 66, Battery unit 70, power management module 68, alarm unit 72, scheduler 73, an IEEE 802.11 chipset 74 and antenna set 76, cellular chipset 78 and associated antenna set 80.

An advantage of this embodiment resides in the fact that there is no display and other user interface related fancy components and can be manufactured separately.

Another advantage of this embodiment is that the user doesn't have to hold it to make a call therefore signal body loss can be avoided.

When in operation, handheld unit can be separated from pocket unit. The pocket unit can be put aside or in the bag or hang on the belt etc. It can relax the health concerns particularly when cellular systems move to lower frequencies such as 700 MHz or even lower. Another advantage resides in the fact that the antenna is off the hand therefore less antenna loss can be achieved for longer distance.

We will briefly illustrate how to use handheld to make a voice call. Similar procedures can be applied to data transfer as well.

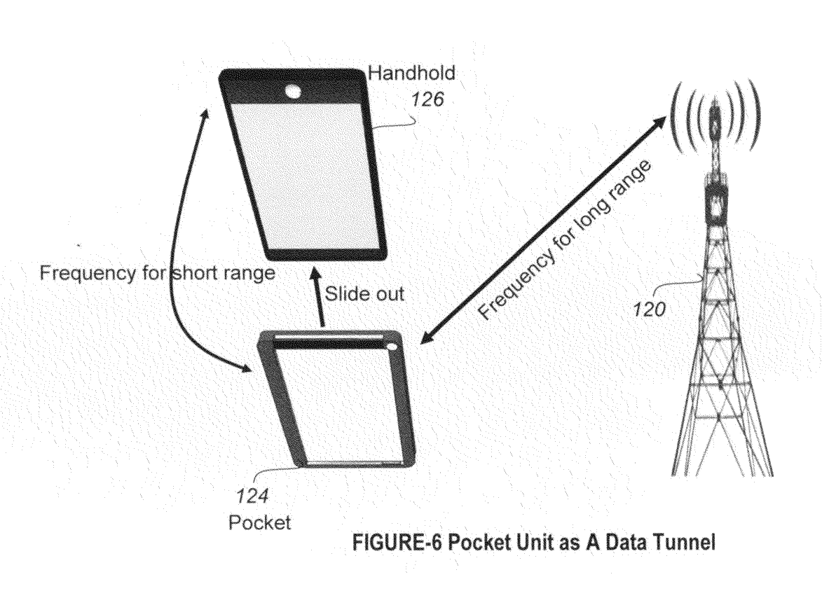

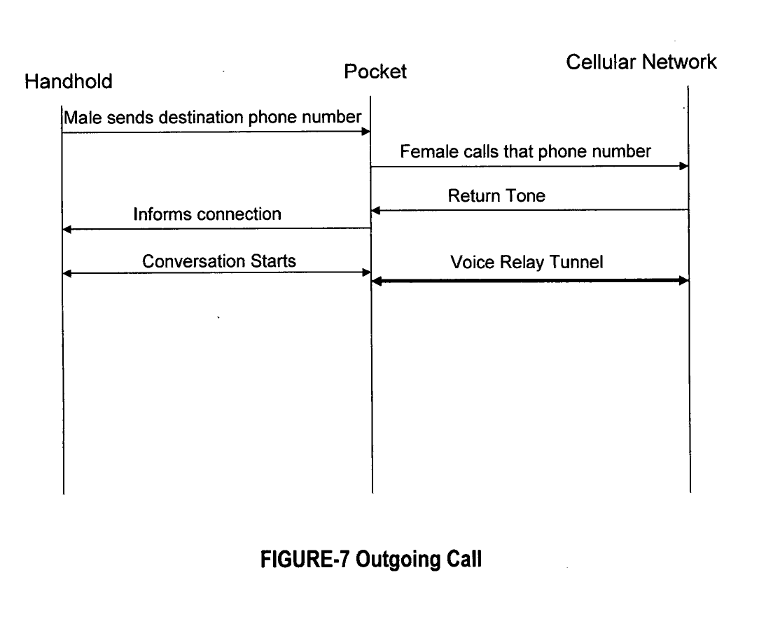

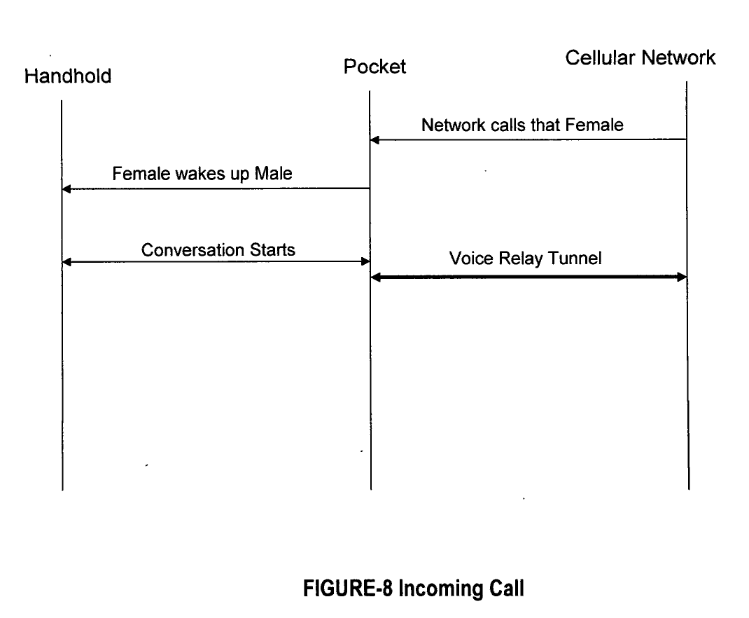

Referring to FIGS. 6, 7 and 8, when user wants to make a call, the user dial the number through the keypad or touch screen 48 of the handheld (refer FIG. 4); The dialed number will be forwarded to pocket unit (refer to FIG. 5) through IEEE 802.11 chipset; the pocket unit IEEE 802.11 antenna 76 will percept it and IEEE chipset 74 will decode it and transfer the decoded number to the coprocessor 66 which will redial the number as the normal cell phone did; after received the connection tone, the pocket unit will inform the handheld unit via 802.11 chipset and the dialog can start.

The voice goes through microphone to the voice codec 42 which takes 8000 samples per second and each sample is encoded by 8 bits; this results into 64 kbps data rate; after encryption and protocol formatting, the voice bits stream will be waveform coded via IEEE 802.11 chipset and transmitted through the antenna set 60. The antenna 76 in pocket unit will receive the signal and IEEE chipset 74 will decode the voice packet and forward it to coprocessor 66; the coprocessor 66 will further process the packet, schedule it and convert the packet stream to fit the cellular protocols and transmitted to cellular network through cellular chipset 78 and antenna set 80.

In reverse direction, the other end voice will be encoded by cellular voice codec (say GSM or CDMA voice codec) and will be transmitted through a cellular base station; upon receiving the voice packet, the cellular chipset 78 in the pocket unit will decode it and then forward it to the coprocessor 66; the coprocessor 66 will further process it and convert it back to PCM format and schedule it to be transmitted via IEEE chipset 74 to the handheld unit; the IEEE 802.11 chipset 58 in the handheld unit will decode it and forward the decoded bits to coprocessor 50 which will further process it and align all the incoming packets to the speaker 40.

We claim:

1. A two-parts wireless phone comprising:
a. A handheld unit
b. A pocket unit
c. The handheld unit can communicate with the pocket unit only within predefined distance.

2. A handheld unit as claimed in claim 1, wherein the handheld unit comprising: an antenna; an IEEE 802.11 chipset in higher frequencies; a coprocessor; a PCM/G711 codec; a ranging alarm unit; a scheduler; microphone and speaker; keypad and display etc.

3. A pocket unit as claimed in claim 1, wherein the pocket unit comprising: an IEEE 802. 11 chipset in higher frequencies and an antenna set; A cellular chipset and an antenna set; a coprocessor; a PCM/G711 codec, cellular codec converter; a ranging alarm unit, a scheduler; a docking unit for handheld etc.

4. The ranging alarm unit as claimed in claim 2 further comprising: an alarm; a software module that regularly pings the pocket unit and calculates the response time and tracks the range; the alarm is triggered when it is out of the predefined range or ping time out.

5. Calculates the response time as claimed in claim 4 includes subtracting the processing time in both handheld unit and in pocket unit.

6. The ranging alarm unit as claimed in claim 3, wherein the ranging alarm unit pings the handheld unit regularly and calculates the range in between and triggers the alarm when the range is beyond the predefined range or the ping time out.

7. The cellular codec converter as claimed in claim 3, wherein the converter converts the cellular codec output bits stream into PCM format bit stream by expanding and converts PCM bit stream into cellular codec bit format by compression.

8. The scheduler as claimed in claim 2, wherein the scheduler will buffer and make alignment of the incoming packets and outgoing packets so that the delay effect get reduced.

9. A docking unit as claimed in claim 3, wherein the docking unit comprising: handheld battery recharge unit; a USB interface; a mini-PCI interface.

10. A docking unit as claimed in claim 3, wherein the docking unit can redirect the data stream to surpass the IEEE 802.11 chipsets in both handheld unit and in pocket unit when handheld unit slides into the pocket.

11. The pre-defined distances as claimed in claim 1 comprising 1 meter, 3 meters, 5 meters, 10 meters, 20 meters and 30 meters.
